(19) United States
(12) Patent Application Publication
(10) Pub. No.: US 2020/0185150 A1
(43) Pub. Date: Jun. 11, 2020

(54) METHOD FOR MANUFACTURING POWDER CORE

(71) Applicant: Toyota Jidosha Kabushiki Kaisha, Toyota-shi (JP)

(72) Inventors: Naoki Iwata, Toyota-shi (JP); Shinjiro Saigusa, Toyota-shi (JP); Masafumi Suzuki, Miyoshi-shi (JP); Minoru Nakamura, Nagoya-shi (JP)

(73) Assignee: Toyota Jidosha Kabushiki Kaisha, Toyota-shi, (JP)

(21) Appl. No.: 16/687,868

(22) Filed: Nov. 19, 2019

(30) Foreign Application Priority Data
Dec. 7, 2018 (JP) 2018-229759

(51) Int. Cl. H01F 41/02; B22F 3/02; B22F 3/24; B22F 5/00; B22F 1/00

(52) U.S. Cl. CPC H01F 41/0246; B22F 3/02; B22F 3/24; B22F 5/00; B22F 2302/45; B22F 2003/023; B22F 2003/248; B22F 2201/02; B22F 1/0059

(57) ABSTRACT

A method for manufacturing a powder core includes: making a mixed powder of a magnetic metal powder, a lubricant, and a glass powder; making a molded body by pressing the mixed powder; removing the lubricant from the molded body; and annealing the molded body from which the lubricant has been removed.

### CROSS-REFERENCE TO RELATED APPLICATION

This application claims priority to Japanese Patent Application No. 2018-229759, filed on Dec. 7, 2018, the entire contents of which are incorporated herein by reference.

### TECHNICAL FIELD

The technology disclosed herein relates to a method for manufacturing a powder core.

### BACKGROUND

Powder cores are used in rotors/stators of electric motors, cores of transformers, cores of reactors, etc. A powder core is a molded body made by pressing and solidifying a magnetic metal powder.

Japanese Patent Application Publication No. 2017-45926 discloses an example of a method for manufacturing a powder core. The manufacturing method is performed as follows. A mixed powder is made by mixing a magnetic metal powder, a lubricant, and a glass powder. The mixed powder obtained is pressed to form a molded body. Then, the molded body obtained is annealed. Adding the glass powder improves strength of the powder core. Moreover, adding the lubricant uniformly distributes the glass powder on surfaces of magnetic metal particles in the mixed powder.

### SUMMARY

An increase in an amount of added glass powder improves the strength of the powder core. However, if the amount of added glass powder is increased, a saturation magnetic flux density of the powder core decreases. The technology described herein is provided to enhance the strength of a powder core manufactured with a glass powder by another method, instead of increasing the amount of glass powder.

A method for manufacturing a powder core disclosed herein may comprise: making a mixed powder of a magnetic metal powder, a lubricant, and a glass powder; making a molded body (which is a semi-finished good of the powder core) by pressing the mixed powder; removing the lubricant from the molded body; and annealing the molded body from which the lubricant has been removed.

In the annealing, the molded body is heated to a temperature above a melting point (softening point) of the glass powder. In a conventional manufacturing method, the lubricant included in the molded body is removed by the heating in the annealing. However, when the lubricant has volatilized/combusted in the annealing, the melted glass powder is deprived of oxygen. It was found that if a glass powder is re-solidified in a state of being deficient in oxygen, the glass powder resultingly has a lowered strength than the intensity the glass inherently would have. In this regard, the manufacturing method disclosed herein removes the lubricant from the molded body prior to the annealing. By annealing after removing the lubricant, the oxygen deficient state is resolved, resulting in obtainment of the inherent strength of glass. As a result, the strength of the powder core is improved compared to conventional ones. It should be noted that it is preferable that the lubricant is fully removed from the molded body, but may not be fully removed and some portion may remain. Removal of even a small amount of a lubricant can allow for improvement of a strength of a powder core.

In the removing, in order to remove the lubricant by vaporization or combustion, the molded body may be heated to a temperature above a vaporization temperature of the lubricant. The lubricant can be removed while the glass powder is not melted by heating the molded body to such a temperature in the removing.

In the removing, the molded body may be heated to a temperature that is above the vaporization temperature of the lubricant and of 500 degrees Celsius or lower. In the removing, the removal of the lubricant is accelerated by heating the molded body in an atmosphere. Further, if the molded body is heated to above 500 degrees Celsius, iron loss from the finished powder core increases although the lubricant is removed.

In the annealing, the molded body may be heated to a temperature above a melting point of the glass powder. By melting and re-solidifying the glass, the strength of the powder core is enhanced. When a low-melting point glass is used, in the annealing, the molded body may be heated to a temperature above 600 degrees Celsius. Further, in the annealing, the molded body may be heated in nitrogen gas.

Details and further improvements of the technique disclosed herein will be described in the Detailed Description as below.

### BRIEF DESCRIPTION OF DRAWINGS

FIG. 1 is a flowchart showing a manufacturing method of an embodiment.

FIG. 2 is a table showing manufacturing conditions for test pieces.

FIG. 3 is a graph showing strength improvement rates of the test pieces.

FIG. 4 is a graph showing iron loss increase rates of the test pieces.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure herein. Furthermore, each of the additional features and teachings disclosed below may be utilized separately or in conjunction with other features and teachings to methods for manufacturing powder cores.

Moreover, combinations of features and steps disclosed in the following detailed description may not be necessary to practice the disclosure herein in the broadest sense, and are instead taught merely to particularly describe representative examples of the disclosure herein. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

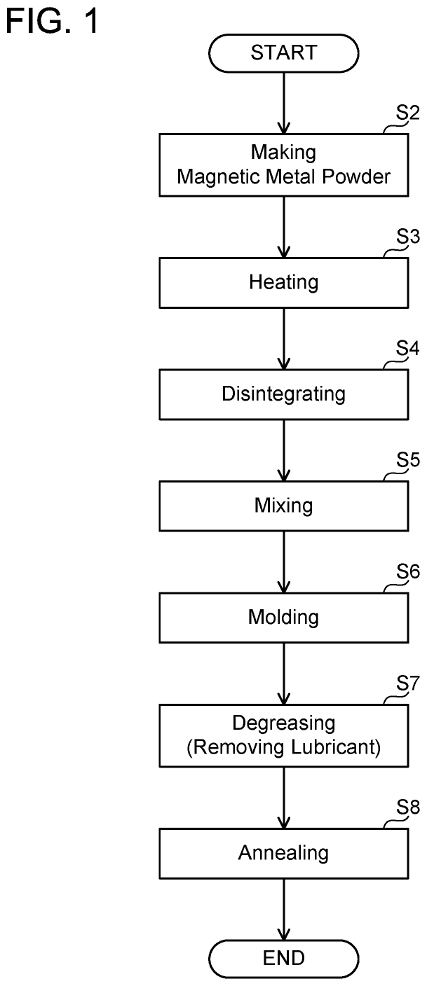

FIG. 1 shows a flowchart of a manufacturing method of an embodiment. The manufacturing method of the embodiment will be descried with reference to the flowchart of FIG. 1.

(Step S2: Magnetic Metal Powder Making Step) First, powder of magnetic metal (soft magnetic metal) is made. An atomization method is suitable for making the magnetic metal powder, but not limiting. The atomization method is a method of producing a powder by spraying air or the like onto a thin stream of a melted metal (or alloy) such that the melted metal is scattered and rapidly solidified. A substance to be sprayed may be a gas or a liquid. As the soft magnetic metal, a Fe—Si—Al based alloy is suitable, but is not limiting. Specifically, a preferable Fe—Si—Al based alloy may contain, 0.5 [% by weight] to 5.0 [% by weight] aluminum (Al), and 0.5 [% by weight] to 9.0 [% by weight] silicon (Si), the balance being iron (Fe). However, the magnetic metal powder is not limited to the substances listed above.

(Step S3: Heating Step) The magnetic metal powder produced in step S2 is heated to thereby form an insulating film of aluminum oxide on the surfaces of powder particles. In this step, the magnetic metal powder is maintained at a temperature between 650 degrees Celsius and 1000 degrees Celsius for a period of time between 0.5 hours and 5 hours.

(Step S4: Disintegrating Step) In a case where the powder is agglomerated in the heating step, the agglomerated powder is disintegrated (crashed) into uniform particles of the powder in this step.

(Step S5: Mixing Step) A mixed powder is made by mixing a lubricant and a glass powder with the magnetic metal powder obtained from steps S2 to S4. The glass powder is added to increase a strength of a magnetic core to be made. The lubricant is added for better mixing of the magnetic metal powder and the glass powder. The lubricant is added for uniform distribution of the glass powder particles on the surfaces of the metal powder particles. The lubricant also contributes to agglomeration of the metal particles when the mixed powder is pressed in a subsequent molding step. The lubricant also facilitates removal of a molded body from a mold.

As the glass powder, a low-melting point glass is used. The low-melting point glass preferably has a melting point (softening point) of 600 degrees Celsius or lower. As the low-melting point glass, a glass that has a melting point higher than a vaporization temperature of the lubricant, which will be described later, is used. More preferably, the low-melting point glass may have a melting point between 500 degrees Celsius and 600 degrees Celsius. Examples of materials usable for the low-melting point glass include borosilicate-based, barium borosilicate-based, barium borate-based, aluminophosphate-based, phosphate-based, and bismuth silicate-based glass powders. The particles of the glass powder preferably have an average particle diameter of approximately 1 to 10 μm. However, the glass powder is not limited to the substances listed above.

For example, one or more substances selected from fatty acid amides, higher alcohols, and the like are used as the lubricate. A substance that has a vaporization temperature lower than the melting point of the glass powder to be mixed with is used as the lubricant. For example, the vaporization temperature of erucic acid amide is 473.86 degrees Celsius, and the vaporization temperature of stearic acid amide is 250 degrees Celsius. The vaporization temperature of oleic acid monoamide is 200 degrees Celsius. These vaporization temperatures are lower than the melting points of the low-melting point glasses listed above. For example, the melting point of the borosilicate-based glass is 500 degrees Celsius.

In the mixing step, the above-mentioned materials (magnetic metal powder, glass powder, and lubricant) are mixed together. The powder thus obtained by the mixing is hereinafter referred to as a mixed powder. A ratio of the added lubricant to total weight of the mixed powder is preferably between 0.1 [% by weight] and 0.6 [% by weight]. The mixing of the magnetic metal powder, the glass powder, and the lubricant is carried out at a temperature lower than the vaporization temperature of the lubricant. The addition of the lubricant produces a powder that has glass particles uniformly distributed on the respective surfaces of particles of the magnetic metal powder.

(Step S6: Molding Step) In a molding step, the molded body is obtained by pressing the mixed powder made in the mixing step. The mixed powder is filled into a mold. The mixed powder filled in the mold is solidified by applying pressure thereto. The pressure applied to the mixed powder is preferably between 100 [MPa] and 2000 [MPa]. Pressing the mixed powder for a predetermined period of time makes the mixed powder solidified. The solidified mixed powder is hereinafter referred to as a molded body. Note that the molded body corresponds to a semi-finished good of the powder core. Also note that the mixed powder filled in the mold may be heated while being pressed. In this case, the mixed powder is maintained at a temperature above the melting point of the lubricant and below the vaporization temperature of the lubricant. The melting of the lubricant improves lubrication between the magnetic metal particles. In addition, the lubricant is diffused into between the mold and the molded body, facilitating the removal of the molded body from the mold.

(Step S7: Degreasing Step) Prior to an annealing step in step S8, the lubricant is removed from the molded body. Since the lubricant is an oil-based material, a step of removing the lubricant is referred to as a degreasing step herein.

In the degreasing step (lubricant removing step), the molded body is heated to a temperature above the vaporization temperature of the lubricant and below the melting point of the glass powder. In a case where the glass powder contained in the mixed powder has a melting point above 500 degrees Celsius, the molded body is heated to a temperature of 500 degrees Celsius or lower and above the vaporization temperature of the lubricant. The molded body is heated in an atmosphere. Then, the lubricant in the molded body is vaporized (or combusted), so that the lubricant is removed from the molded body. Since the molded body is heated to a temperature lower than the melting point of the glass powder, the degreasing step does not affect the glass powder.

(Step S8: Annealing Step) In the annealing step, the molded body is heated to a temperature above the melting point of the glass powder. The molded body is heated in nitrogen gas. When the glass powder has a melting point of 600 degrees Celsius or lower, the molded body is heated to a temperature above 600 degrees Celsius in the annealing step. The molded body is maintained in nitrogen gas, for example, at a temperature between 600 degrees Celsius and 900 degrees Celsius for a period of time between 15 minutes and 60 minutes.

The annealing removes strain generated in the metal particles when they were pressed in the molding step. The glass powder is melted by the annealing. In the molded body, the melted glass powder is re-solidified, thereby improving the strength of the molded body (powder core). The molded body after the annealing corresponds to a powder core. That is, when the annealing has finished, the powder core is completed.

In a conventional manufacturing method, a degreasing step (lubricant removing step) was not performed before annealing. In this case, when the molded body is heated in the annealing step, the glass powder is melted, and concurrently the lubricant is vaporized or combusted. When the lubricant is combusted, the melted glass powder is deprived of oxygen. When the glass powder deprived of oxygen is re-solidified, the strength of the molded body decreases, compared to a case where oxygen is not deprived. In the manufacturing method disclosed herein, the lubricant is removed from the molded body prior to annealing. Thus, the glass is not deprived of oxygen in the annealing step. As a result, a powder core with higher strength than in the prior art can be obtained. It is preferable that the lubricant is completely removed in the degreasing step. However, if any amount of lubricant is removed in the degreasing step, an improvement in the strength of the powder core can be expected.

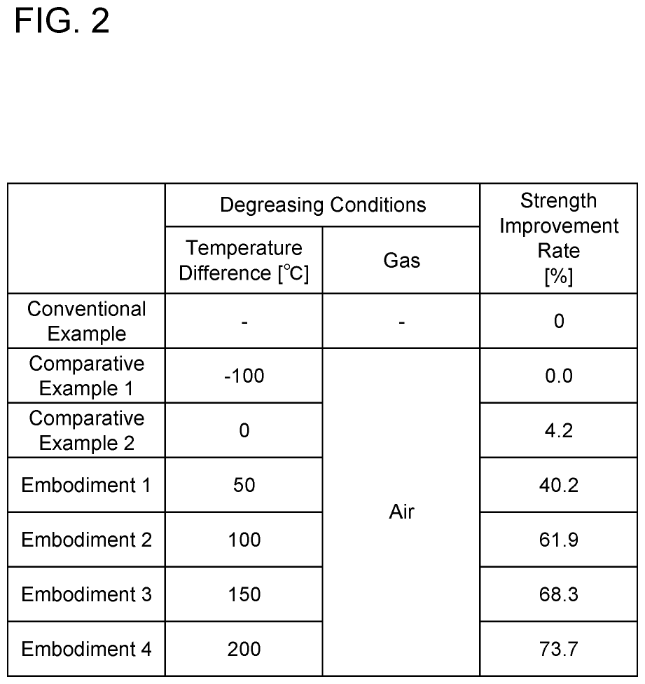

A test was performed to confirm the effect of the degreasing step (lubricant removing step). A Fe—Si—Al-based alloy was used as material for a magnetic metal powder. A plurality of test pieces of ring-shaped powder cores were prepared according to the processes shown in FIG. 1. The test pieces were prepared under multiple conditions. FIG. 2 shows the conditions of the degreasing step and strength evaluation results of the test pieces prepared under the respective conditions. The test piece named “Conventional” indicates a test piece that was not subjected to the degreasing step (lubricant removing step). Stearic acid amide (having a vaporization temperature of 250 degrees Celsius) was used as a lubricant. A borosilicate-based glass powder (having a melting point-of 500 degrees Celsius) was used as a glass powder.

“Temperature difference” used in FIG. 2 indicates a difference between the vaporization temperature of the lubricant and the temperature of the molded body in the degreasing step. “Temperature difference: minus 100 degrees” in Comparative Example 1 means that the molded body was heated only to a temperature that is lower by 100 degrees than the vaporization temperature of the lubricant. “Temperature difference: 0 degree” in Comparative Example 2 means that the molded body was heated up to the same temperature as the vaporization temperature of the lubricant. All test pieces except for the “Conventional” one were degreased in an atmosphere. That is, all the test pieces except for the “conventional” one were heated in the atmosphere in the degreasing step. Furthermore, all the test pieces were annealed in nitrogen gas.

The strength of each test piece was evaluated by performing a radial crushing strength test on the test piece. The radial crushing strength test was performed in a manner conforming to JIS Z-2507. Strength improvement rates of other test pieces are shown in percentages, assuming that the radial crushing strength of the “Conventional” test piece is 1.0.

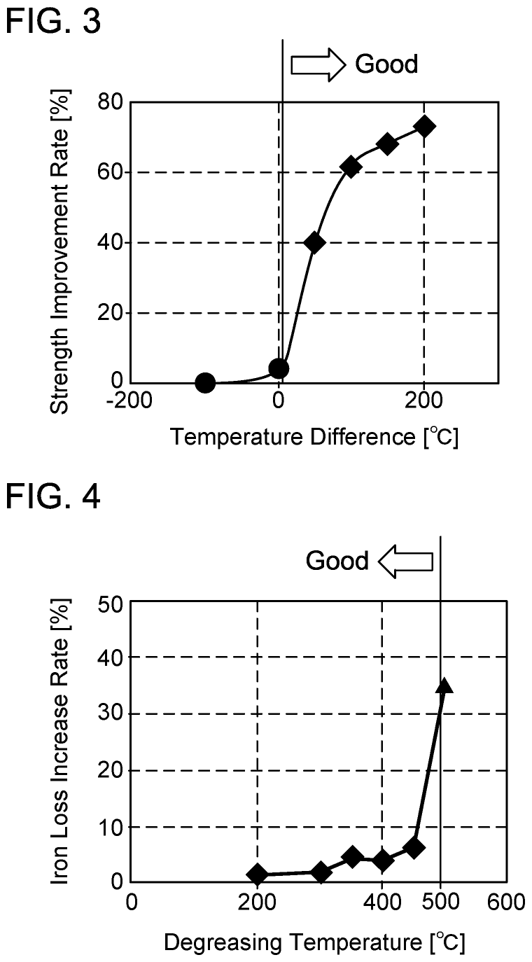

FIG. 3 is a graph showing the strength improvement rates of FIG. 2. In this graph, circle marks indicate the results of Comparative Examples, whereas square marks indicate the results of embodiments. It was confirmed that if the temperature difference exceeded zero, that is, if the test piece was heated to a temperature higher than the vaporization temperature of the lubricant, the strength of the test piece (powder core) was improved, compared to the test piece that was not subjected to the degreasing step.

Another test piece was made to examine an increase rate in iron loss. As a magnetic metallic powder, a Fe—Si—Al alloy was used. In the degreasing step, molded bodies (test pieces) were heated to various temperatures and then annealed. The iron loss of each molded body (test piece) after the annealing was measured. FIG. 4 shows the iron loss increase rate of each test piece, under assumption that the iron loss of the test piece is 1.0 when the degreasing step is not performed. The smaller the iron loss, the better. In FIG. 4, triangle marks indicate the comparative Examples, whereas square marks indicate the embodiments. It is found by FIG. 4 that when the temperature in the degreasing step is 500 degrees Celsius or lower, the iron loss increase rate is small. This is because when the test piece is heated to 500 degrees or higher in the atmosphere, iron (Fe) in the test piece is oxidized, resulting in an increase in iron loss. That is, the molded body in the degreasing step (lubricant removing step) is preferably heated to a temperature above the vaporization temperature of the lubricant and of 500 degrees Celsius or lower.

The technology disclosed herein can be applied to powder cores used in a variety of devices. The materials of the magnetic metal powder, the glass powder, and the lubricant are not limited to the substances exemplified in the embodiments. Since the lubricant used in the embodiments is an oil-based one, the step of removing lubricant is referred to as the “degreasing step”. However, the lubricant is not limited to the oil-based one. When using a lubricant which is not oil-based, the lubricant removing step is not referred to as the “degreasing step” but may be simply referred to as the “lubricant removing step”.

In the degreasing step (lubricant removing step) of the embodiments, the molded body is heated to the temperature above the vaporization temperature of the lubricant and below the melting point of the glass powder. In the lubricant removing step, the molded body may be heated to a temperature of the melting point of the glass powder or higher. For example, when the glass powder has a melting point of 500 degrees Celsius or higher (or a melting point above 500 degrees Celsius), the molded body may be heated to a temperature above the vaporization temperature of the lubricant and lower than 500 degrees Celsius (or 500 degrees Celsius or lower) in the lubricant removing step. However, the molded body may be heated to 500 degrees Celsius or higher in the lubricant removing step as long as the vaporization temperature of the lubricant is lower than the melting point of the glass powder. Even when the molded body is heated to 500 degrees Celsius or higher in the lubricant removing step, the strength of the molded body after the annealing is improved.

There may be a case where the low-melting point glass has a melting point of 600 degrees Celsius or lower. When such a low-melting point glass is used, the molded body may be preferably heated to a temperature above 600 degrees Celsius in the annealing step.

What is claimed is:

1. A method for manufacturing a powder core, the method comprising:
making a mixed powder of a magnetic metal powder, a lubricant, and a glass powder;
making a molded body by pressing the mixed powder;
removing the lubricant from the molded body; and
annealing the molded body from which the lubricant has been removed.

2. The method of claim 1, wherein, in the removing, the molded body is heated to a temperature above a vaporization temperature of the lubricant.

3. The method of claim 2, wherein, in the removing, the molded body is heated to a temperature of 500 degrees Celsius or lower.

4. The method of claim 2, wherein, in the removing, the molded body is heated in an atmosphere.

5. The method of claim 1, wherein, in the annealing, the molded body is heated to a temperature above a melting point of the glass powder.

6. The method of claim 5, wherein, in the annealing, the molded body is heated to a temperature above 600 degrees Celsius.

7. The method of claim 5, wherein, in the annealing, the molded body is heated in nitrogen gas.
